(19) United States
(12) Patent Application Publication
(10) Pub. No.: US 2004/0245086 A1
(43) Pub. Date: Dec. 9, 2004

(54) Production of synthesis gas and synthesis gas derived products

(76) Inventors: Andre Peter Steynberg, Vanderbijlpark (ZA); Barry Anthony Tindall, Vaalpark (ZA); Craig Macgregor, Sasolburg (ZA)

Correspondence Address: SNELL & WILMER, ONE ARIZONA CENTER, 400 EAST VAN BUREN, PHOENIX, AZ, 850040001

(21) Appl. No.: 10/487,477

(22) PCT Filed: Aug. 19, 2002
(86) PCT No.: PCT/IB02/03322

Related U.S. Application Data
(60) Provisional application No. 60/314,122, filed on Aug. 22, 2001.

(51) Int. Cl. C01B 3/26; H05F 3/00

(52) U.S. Cl. 204/164; 423/651

(57) ABSTRACT

A process for upgrading raw synthesis gas comprising at least CH4, CO2, CO and H2, includes heating the raw synthesis gas by addition of energy derived from electricity to provide an upgraded synthesis gas comprising less CH4 and CO2 and more CO and H2 than the raw synthesis gas. The invention extends to a process for producing synthesis gas, which process includes reforming a hydrocarbonaceous gas feedstock which includes CH4 to raw synthesis gas comprising at least CH4, CO2, CO and H2, and upgrading the raw synthesis gas in a process which includes heating the raw synthesis gas by addition of energy derived from electricity to provide an upgraded synthesis gas comprising less CH4 and CO2 and more CO and H2 than the raw synthesis gas.

THIS INVENTION relates to the production of synthesis gas and synthesis gas derived products. In particular, it relates to a process for upgrading raw synthesis gas, to a process for producing synthesis gas, and to a process for producing a synthesis gas derived product.

Analysis of the efficiency of the Fischer-Tropsch process used by the applicant to produce liquid fuels shows that for one particular application only about 75% of carbon entering the process as feedstock ends up in the desired products of the process. The largest portion (about 38%) of the 25% of the carbon not ending up in the desired products, was found to be lost in the form of CO₂, formed in synthesis gas production stages and concentrated in the Fischer-Tropsch hydrocarbon synthesis stage. The CO₂ is usually purged as part of a fuel gas stream originating from the Fischer-Tropsch hydrocarbon synthesis stage.

The cost of producing oxygen for use in the production of synthesis gas represents about 53% of the costs of converting a carbonaceous or hydrocarbonaceous feedstock into liquid fuels, using the Fischer-Tropsch or similar processes. As will be appreciated, a process using less oxygen and which wastes less carbon and oxygen in the form of CO₂, will have cost benefits over conventional processes.

According to one aspect of the invention, there is provided a process for upgrading raw synthesis gas comprising at least CH₄, CO₂, CO and H₂, the process including heating the raw synthesis gas by addition of energy derived from electricity to provide an upgraded synthesis gas comprising less CH₄ and CO₂ and more CO and H₂ than the raw synthesis gas.

According to a further aspect of the invention, there is provided a process for producing a synthesis gas derived product, which process includes

providing a raw synthesis gas comprising at least CH₄, CO₂, CO and H₂;

in a synthesis gas upgrading stage, heating the raw synthesis gas by addition of energy derived from electricity to provide an upgraded synthesis gas comprising less CH₄ and CO₂ and more CO and H₂ than the raw synthesis gas; feeding the upgraded synthesis gas, as a feedstock, to a synthesis gas conversion stage; and

in the synthesis gas conversion stage, converting the upgraded synthesis gas to a synthesis gas derived product.

Typically, the raw synthesis gas includes H₂O, and the process includes removing most of the H₂O, e.g. by condensation, from the upgraded synthesis gas prior to converting the upgraded synthesis gas to a synthesis gas derived product.

Providing a raw synthesis gas may include reforming a hydrocarbonaceous gas feedstock which includes CH₄.

The raw synthesis gas is thus heated to promote further reforming of CH₄ to increase the H₂ and CO concentration in the gas, and to promote the reaction of H₂ with CO₂ present in the raw synthesis gas to further increase the CO concentration in the gas (i.e. to promote the so-called reverse shift reaction), thereby providing the upgraded synthesis gas comprising less CH₄ and CO₂ and more CO and H₂ than the raw synthesis gas.

The raw synthesis gas is heated using electrical energy, and in particular the raw synthesis gas may be heated by means of an electrically driven plasma torch. As will be appreciated, to improve the efficiency and economics of the process, it is desirable to elevate the temperature of the raw synthesis gas, taking into account the ability of process equipment, such as a refractory lined vessel which is in contact with the hot upgraded synthesis gas, to withstand the high temperature of the synthesis gas. The raw synthesis gas may thus be heated to a temperature of between about 1000° C. and about 1600° C., preferably between about 1000° C. and about 1200° C., e.g. about 1050° C.

It is an advantage of the invention that the electrical energy can be generated using waste heat from the upgraded synthesis gas and, when present, from the synthesis gas conversion stage. Thus, at least a portion of the electricity may be generated from waste heat from the upgraded synthesis gas. At least a portion of the electricity may be generated from waste heat from the synthesis gas conversion stage.

The process may thus include cooling the upgraded synthesis gas. Heat removed from the upgraded synthesis gas may be used to generate steam, which may in turn be used to drive a steam turbine of a steam turbine-driven electricity generator to provide the electricity for generating the plasma torch. It will be appreciated that the invention will be particularly advantageous at locations where low cost electricity is available or can be made available. One example of such a situation is when remote natural gas is converted to liquid hydrocarbon products using the well-known Fischer-Tropsch synthesis. The waste heat from the Fischer-Tropsch conversion process can be converted to electrical energy at low cost. Due to the remote location, there is no other suitable use for either the excess heat generated in the Fischer-Tropsch synthesis or the excess electrical energy that can be produced from this heat.

In one embodiment of the invention, the synthesis gas conversion stage is a Fischer-Tropsch hydrocarbon synthesis stage. However, it is to be appreciated that the synthesis gas conversion stage may be any synthesis stage requiring synthesis gas, such as a methanol, higher alcohol or oxoalcohol synthesis stage. The details of the synthesis gas production stage for methanol, higher alcohol or oxoalcohol synthesis will be different from that of the synthesis gas production stage for Fischer-Tropsch hydrocarbon synthesis. Although it is thus likely that the waste heat from the synthesis gas conversion stage for methanol, higher alcohol or oxoalcohol synthesis will be less than the waste heat for a Fischer-Tropsch hydrocarbon synthesis process, and thus that less electrical energy can be generated from the waste heat of a process which includes a methanol, higher alcohol or oxoalcohol synthesis stage, the process of the invention may still provide advantages over conventional processes if low cost electrical energy is available.

The Fischer-Tropsch hydrocarbon synthesis stage may be provided with any suitable reactor such as a tubular fixed bed reactor, a slurry bed reactor or an ebullating bed reactor. The pressure in the reactor may be between 1 bar and 100 bar, while the temperature may be between 200° C. and 380° C. The reactor will thus contain a Fischer-Tropsch catalyst, which will be in particulate form. The catalyst may contain, as its active catalyst component, Co, Fe, Ni, Ru, Re and/or Rh. The catalyst may be promoted with one or more promoters selected from an alkali metal, V, Cr, Pt, Pd, La, Re, Rh, Ru, Th, Mn, Cu, Mg, K, Na, Ca, Ba, Zn and Zr. The catalyst may be a supported catalyst, in which case the active catalyst component, e.g. Co, is supported on a suitable support such as Al₂O₃, TiO₂, SiO₂, ZnO or a combination of these.

According to another aspect of the invention, there is provided a process for producing synthesis gas, which process includes

reforming a hydrocarbonaceous gas feedstock which includes CH₄ to raw synthesis gas comprising at least CH₄, CO₂, CO and H₂; and

upgrading the raw synthesis gas in a process which includes heating the raw synthesis gas by addition of energy derived from electricity to provide an upgraded synthesis gas comprising less CH₄ and CO₂ and more CO and H₂ than the raw synthesis gas.

Reforming the hydrocarbonaceous gas feedstock may include adiabatically pre-reforming the hydrocarbonaceous gas feedstock with steam to provide a pre-reformed gas. A steam to carbon molecular ratio of between about 0.2 and about 1.5 may be employed to adiabatically pre-reform the hydrocarbonaceous gas feedstock.

Reforming the hydrocarbonaceous gas feedstock may include autothermally reforming the pre-reformed gas, or the hydrocarbonaceous gas feedstock, as the case may be, with oxygen. The process may include controlling the ratio of oxygen to pre-reformed gas or hydrocarbonaceous gas feedstock to control the temperature of the raw synthesis gas produced to below 1050° C. but above the temperature at which soot formation occurs. In one embodiment of the invention, the temperature of the raw synthesis gas produced is less than 950° C., e.g. about 900° C. As will be appreciated, by controlling the raw synthesis gas temperature to less than the conventional temperature of 1050° C., less oxygen is used than in conventional processes, leading to an immediate cost saving, but less CO and H₂ are produced, bearing in mind that the autothermal oxygen burning reforming process uses a catalyst that achieves a gas composition that is close to equilibrium at the temperature of the raw synthesis gas.

The oxygen may be obtained from a cryogenic air separation plant in which air is compressed and separated cryogenically into oxygen and nitrogen.

The process may include a hydrocarbonaceous gas feedstock pre-treatment stage, which may include a gas feedstock preheating stage and/or a sulphur removal stage. In the gas feedstock preheating stage, the hydrocarbonaceous gas feedstock is typically preheated to in excess of 400° C., e.g. to about 430° C. or higher.

The process for upgrading the raw synthesis gas may be a process as hereinbefore described.

The hydrocarbonaceous gas feedstock may be natural gas, or a gas found in association with crude oil, comprising CH₄ as a major component and other hydrocarbons.

According to yet a further aspect of the invention, there is provided a process for producing synthesis gas, which process includes

gasifying a carbonaceous feedstock under conditions suitable to provide a raw synthesis gas comprising at least CH₄, CO₂, CO and H₂; and

upgrading the raw synthesis gas in a process which includes heating the raw synthesis gas by addition of energy derived from electricity to provide an upgraded synthesis gas comprising less CH₄ and CO₂ and more CO and H₂ than the raw synthesis gas.

The carbonaceous feedstock may be a solid such as coal or petroleum coke or other solid carbonaceous feedstock that is capable of conversion to synthesis gas, e.g. using the well-known Lurgi moving bed gasifier. Gasification of the carbonaceous solid feedstock may take place at conventional conditions.

The process for upgrading the raw synthesis gas may be a process as hereinbefore described. Typically, the raw synthesis gas includes H₂O.

The invention will now be described, by way of example, with reference to the accompanying drawings and the Examples.

In the drawings

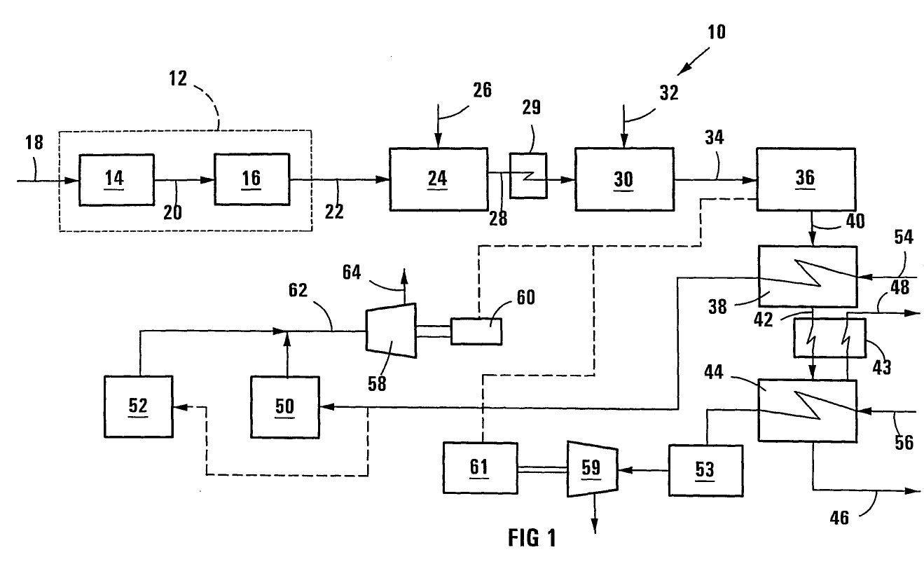

FIG. 1 shows a simplified flow diagram of one embodiment of a process in accordance with the invention for producing a synthesis gas derived product; and

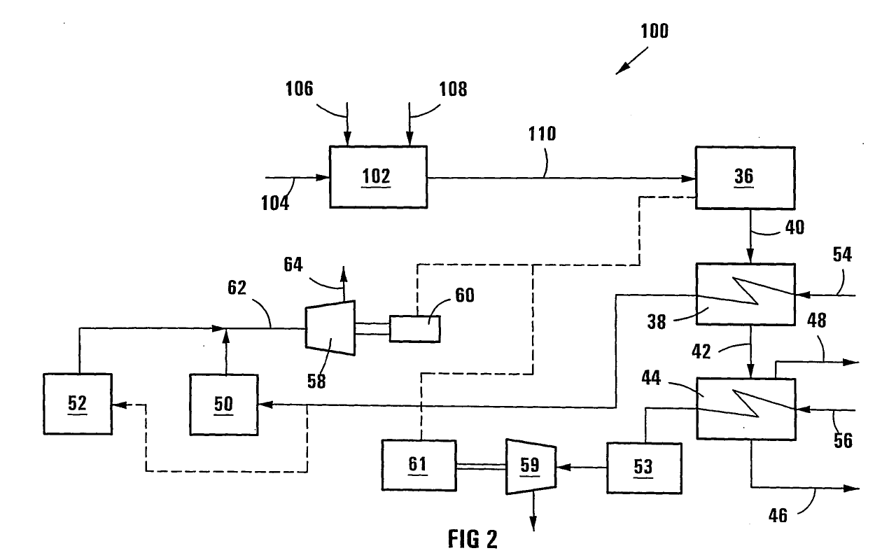

FIG. 2 shows a simplified flow diagram of another embodiment of a process in accordance with the invention for producing a synthesis gas derived product.

Referring to FIG. 1 of the drawings, reference numeral 10 generally indicates one embodiment of a process according to the invention for producing a synthesis gas derived product.

The process 10 includes a hydrocarbonaceous gas feedstock pre-treatment stage 12 comprising a gas feedstock pre-heating stage 14 and a sulphur removal stage 16, with a natural gas feed line 18 leading into the stage 14 and a preheated gas line 20 leading from the stage 14 to the stage 16.

From the sulphur removal stage 16, a gas feed line 22 leads into an adiabatic pre-reformer 24, into which a steam feed line 26 also feeds.

A pre-reformed gas line 28 leads from the adiabatic pre-reformer 24 to a fired heater 29 and from there to an autothermal reformer 30, into which an oxygen feed line 32 also leads. The reformer 30 is thus an oxygen-blown autothermal reformer comprising a refractory-lined vessel, a burner and a catalyst bed.

A raw synthesis gas line 34 leads from the autothermal reformer 30 into a heater 36.

The heater 36 is followed by a heat exchange unit 38 which is connected to the heater 36 by means of an upgraded synthesis gas line 40. However, if desired, the heater 36 may be followed by a reformer which includes a reforming catalyst (not shown).

A cooled synthesis gas line 42 leads from the heat exchange unit 38 to a heat exchanger 43 and from the heat exchanger 43 to a synthesis gas conversion stage 44 which is a Fischer-Tropsch hydrocarbon synthesis stage. A separator (not shown) for the separation of condensed liquid product consisting mainly of water is typically located between the heat exchange unit 38 and the heat exchanger 43. A liquid phase withdrawal line 46 and a vapour phase withdrawal line 48 lead from the synthesis gas conversion stage 44 to a product upgrading stage (not shown). The vapour phase withdrawal line 48 passes through the heat exchanger 43 before reaching the product upgrading stage.

The process 10 further includes a high pressure boiler 50 and a start-up boiler 52, as well as a medium pressure boiler 53. Boiler water lines 54, 56 respectively pass through the heat exchange unit 38 and the synthesis gas conversion stage 44 before leading into the boiler 50 and/or 52, as desired, and the boiler 53.

The process 10 further includes a high pressure steam turbine 58 to drive an electricity generator 60, the steam turbine 58 being fed by a steam line 62 from the boiler 50 and start-up boiler 52. A low pressure steam line 64 leads from the steam turbine 58. A medium pressure steam turbine 59 fed from the boiler 53 is provided to drive an electricity generator 61.

Although not shown in the drawing, the process 10 typically includes other process units, such as a steam condenser into which the low pressure steam line 64 feeds, a boiler feedwater system, etc. However, these process units are well known to those skilled in the art and thus do not require description.

In use, natural gas comprising mainly CH₄ is introduced along the natural gas feed line 18 into the gas feedstock pre-heating stage 14. Typically, in the stage 14, the natural gas is preheated to a temperature in excess of 430° C. Thereafter, the preheated natural gas is sweetened by removing sulphur from the gas in the sulphur removal stage 16.

In the adiabatic pre-reformer 24, the sweetened natural gas is adiabatically pre-reformed with steam which enters along the steam feed line 26, to provide a pre-reformed gas. Typically, a steam to carbon molecular ratio of between 0.2 and 1.5, e.g. 0.6 is maintained in the adiabatic pre-reformer 24.

The pre-reformed gas is further pre-treated to temperatures above 400° C. in the heater 29 and fed into the autothermal reformer 30, together with oxygen fed through the oxygen feed line 32. The ratio of oxygen to pre-reformed gas in the autothermal reformer 30 is manipulated to control the temperature inside the auto-thermal reformer 30 at or below 1050° C., but above the temperature at which soot formation occurs.

The autothermal reformer 30 provides a raw synthesis gas comprising at least CH₄, CO, CO₂, H₂O and H₂, which is fed along the raw synthesis gas line 34 to the heater 36. In the heater 36, the raw synthesis gas is heated by means of an electrically generated plasma torch. It is desirable to heat the raw synthesis gas to a higher temperature than typically used for a conventional reformer outlet, which in practice means a temperature of between about 1000° C. and about 1600° C., e.g. 1050° C., depending on the ability of the process equipment to withstand the high temperature of the gas and the desired conversion of CH₄ and CO₂ to H₂ and CO.

In the heater 36, further reaction of CH₄ to provide an upgraded synthesis gas comprising more H₂ and CO is promoted, as a result of the high temperature of the gas. The high temperature of the gas also favours the reaction of CO₂ with H₂ to produce H₂O and CO (the so-called reverse shift reaction). The heated synthesis gas is optionally contacted with a reforming catalyst to promote the desired reactions. The upgraded synthesis gas leaving the heater 36 thus comprises less CH₄ and CO₂ and more CO and H₂ than the raw synthesis gas fed to the heater 36. Typically, the H₂/CO molecular ratio in the upgraded synthesis gas is between 1.9 and 2.3.

In the heat exchange unit 38, the upgraded synthesis gas is cooled to a temperature of about 70° C. by heat exchange with boiler feedwater passing through the heat exchange unit 38 before entering the high pressure boiler 50. The cooled upgraded synthesis gas is then fed along the line 42 into the heat exchanger 43, where it is heated to a temperature of about 120° C. (or higher), before being passed into the synthesis gas conversion stage 44 where it is subjected to a Fischer-Tropsch process. In the stage 44, H₂ and CO in the upgraded synthesis gas are reacted, at a temperature of 200° C. to 280° C. and a pressure of between 1 and 100 bar, typically about 25 bar, and in the presence of a cobalt-based catalyst, using the so-called low temperature Fischer-Tropsch synthesis, to produce a range of hydrocarbon products of different carbon chain lengths. Typically, the products are separated into a liquid phase comprising heavy liquid hydrocarbons, and an overheads vapour phase comprising light hydrocarbon products, unreacted synthesis gas, water and soluble organic compounds such as alcohols. The liquid phase is then withdrawn through the line 46 and typically upgraded by means of hydroprocessing into more valuable products. The vapour phase, after withdrawal through the line 48 at a temperature of between about 180° C. and 240° C., is cooled in the heat exchanger 43 by exchanging heat with the cooled upgraded synthesis gas, before further cooling and condensation and provides an aqueous phase comprising water and soluble organic compounds and a condensed product phase, typically comprising hydrocarbon products having three or more carbon atoms. The condensed product phase is also passed into the product upgrading stage.

Heat is removed from the synthesis gas conversion stage 44 by means of heat exchange with boiler water fed through the synthesis gas conversion stage 44 along the boiler water line 56 into the boiler 53. In the boiler 53, medium pressure steam and water are allowed to separate, with the medium pressure steam being fed to the steam turbine 59. In the boiler 50, high pressure steam and water are allowed to separate, with the high pressure steam being fed to the steam turbine 58. The steam turbines 58 and 59 drive the electricity generators 60 and 61 respectively, which is in electrical connection with the heater 36, where the electricity is used to generate the plasma. For start-up purposes, the start-up boiler 52 is provided, which can be fuelled with gas derived from the synthesis gas conversion stage 44 and/or with natural gas. If desired, the start-up boiler 52 can be run continuously for the generation of electricity.

Referring to FIG. 2 of the drawings, reference numeral 100 generally indicates another embodiment of a process according to the invention for producing a synthesis gas derived product.

The process 100 corresponds in many respects with the process 10 and, unless otherwise indicated, the same reference numerals are used to indicate the same or similar parts or features.

The process 100 includes a moving bed gasifier 102, e.g. a conventional Lurgi moving bed gasifier. A coal feed line 104, an oxygen feed line 106 and a steam feed line 108 lead into the gasifier 102. From the gasifier 102, a raw synthesis gas line 110 leads into the heater 36, from where the process 100 is identical to the process 10, except that a CO₂ removal step (not shown) is required in which CO₂ is removed from the cooled synthesis gas in line 42.

In use, coal is gasified in the gasifier 102 in the presence of oxygen and steam under conventional gasifying conditions. A raw synthesis gas comprising at least CH₄, CO, CO₂, H₂O and H₂ is produced in the gasifier 102 and passed along the synthesis gas line 110 to the heater 36. In the heater 36, the raw synthesis gas is heated by means of a plasma torch as hereinbefore described, to provide an upgraded synthesis gas comprising more H₂ and CO than the raw synthesis gas, before being further treated as hereinbefore described.

### EXAMPLE 1

For comparative purposes a base case gas to liquids Fischer-Tropsch process, similar to the process shown in FIG. 1 but without a plasma torch, was simulated.

For the simulation a hydrocarbonaceous gas feedstock composition as shown in Table 1 was used.

TABLE 1
Natural Gas Composition (molar %)

| Component | Value |
|---|---|
| Methane (CH₄) | 95.7 |
| C₂ | 0.3 |
| Nitrogen (N₂) | 4.0 |

For the purposes of this simulation the hydrocarbonaceous gas feedstock is desulphurised and adiabatically pre-reformed. The hydrocarbonaceous gas feedstock is mixed with steam to provide a pre-reformed gas. A steam to carbon molecular ratio of 0.6 is employed to adiabatically pre-reform the hydrocarbonaceous gas feedstock.

The pre-reformed hydrocarbonaceous gas feedstock is autothermally reformed with oxygen. The simulated process includes controlling the ratio of oxygen to pre-reformed gas or hydrocarbonaceous gas feedstock to control the temperature of the raw synthesis gas produced to 1050° C. The predicted composition of the synthesis gas made by autothermally reforming the pre-reformed hydrocarbonaceous feedstock after knocking out most of the water formed in the autothermal reformer is shown in Table 2.

TABLE 2
Reformed Synthesis Gas Composition ex autothermal
reformer (molar %)

| Component | Value |
|---|---|
| Water (H₂O) | 1.22 |
| Hydrogen (H₂) | 58.25 |
| Carbon Monoxide (CO) | 30.26 |
| Carbon Dioxide (CO₂) | 5.94 |
| Methane (CH₄) | 0.86 |
| Nitrogen (N₂) | 3.47 |

The hydrogen to carbon monoxide ratio (H₂:CO) in the synthesis gas is adjusted by varying the flow rate of a recycle of Fischer-Tropsch tailgas and particularly the carbon dioxide flow rate. The synthesis gas is mixed with an internal recycle around the Fischer-Tropsch synthesis unit and fed to the synthesis unit.

The primary products are sent to a product-upgrading unit and the waxy syncrude is worked up into a diesel, naphtha and LPG fraction. The quantities of marketable product predicted by the simulation are shown in Table 3.

TABLE 3
Marketable Fischer-Tropsch Products (barrels/day)

| Product | Value |
|---|---|
| Fischer-Tropsch Diesel | 24470 |
| Fischer-Tropsch Naphtha | 8110 |
| Fischer-Tropsch LPG | 1310 |
| Total | 33890 |

### EXAMPLE 2

In Example 2 a plasma reformer is used to heat, reform and equilibrate the raw synthesis gas at a temperature higher than that in the autothermal reformer, similar to the process shown in FIG. 1 of the drawings. For the purposes of this simulation an autothermal reformer operating temperature of 1050° C. and a plasma reformer temperature of 1100° C. were used.

The same hydrocarbonaceous feedstock composition was used as shown in Table 1 and a feedstock flow rate which is the same as for the simulation of Example 1, was used.

The pre-reformed hydrocarbonaceous gas feedstock is autothermally reformed with oxygen. The simulated process includes controlling the ratio of oxygen to pre-reformed gas to control the temperature of the raw synthesis gas produced to 1050° C. The raw synthesis gas is further reformed in the plasma reformer by increasing the temperature of the raw synthesis gas in an electrically generated plasma torch to a temperature of 1100° C. The predicted composition of the equilibrated synthesis gas after the plasma reformer after knocking out most of the water formed in the synthesis gas generation process is shown in Table 4.

TABLE 4
Reformed Synthesis Gas Composition ex Plasma Reformer (molar %)

| Component | Value |
|---|---|
| Water (H₂O) | 1.22 |
| Hydrogen (H₂) | 59.06 |
| Carbon Monoxide (CO) | 30.67 |
| Carbon Dioxide (CO₂) | 5.21 |
| Methane (CH₄) | 0.44 |
| Nitrogen (N₂) | 3.4 |

The hydrogen to carbon monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Including the plasma reformer in the simulation results in a predicted saving of 2% in oxygen consumption for the autothermal reformer, compared to the base case of Example 1.

The primary products are sent to a product-upgrading unit and the waxy syncrude is worked up into a diesel, naphtha and LPG fraction. The quantities of marketable product predicted by the simulation are shown in Table 5.

TABLE 5
Marketable Fischer-Tropsch Products (barrels/day)

| Product | Value |
|---|---|
| Fischer-Tropsch Diesel | 24772 |
| Fischer-Tropsch Naphtha | 8160 |
| Fischer-Tropsch LPG | 1321 |
| Total | 34253 |

Including the plasma reformer in the simulation thus increases the production of marketable products by 1.07% over the base case of Example 1. The plasma reformer requires a duty of around 31 MW that is provided by utilizing the excess medium pressure steam generated in the Fischer-Tropsch synthesis unit for generating the electricity to drive the plasma torch.

### EXAMPLE 3

In Example 3 a plasma reformer is used to heat, reform and equilibrate the raw synthesis gas at a temperature higher than that in the autothermal reformer, similar to the process shown in FIG. 1 of the drawings. For the purposes of this simulation an autothermal reformer operating temperature of 900° C. and a plasma reformer temperature of 1100° C. were used.

The same hydrocarbonaceous feedstock composition was used as shown in Table 1 and a feedstock flow rate which is the same as for the simulation of Example 1, was used.

The pre-reformed hydrocarbonaceous gas feedstock is autothermally reformed with oxygen. The simulated process includes controlling the ratio of oxygen to pre-reformed gas to control the temperature of the raw synthesis gas produced to 900° C. The raw synthesis gas is further reformed in the plasma reformer by increasing the temperature of the raw synthesis gas in an electrically generated plasma torch to a temperature of 1100° C. The predicted composition of the equilibrated synthesis gas after the plasma reformer after knocking out most of the water formed in the synthesis gas generation process is shown in Table 6.

TABLE 6
Reformed Synthesis Gas Composition ex Plasma Reformer (molar %)

| Component | Value |
|---|---|
| Water (H₂O) | 1.22 |
| Hydrogen (H₂) | 55.20 |
| Carbon Monoxide (CO) | 28.67 |
| Carbon Dioxide (CO₂) | 3.10 |
| Methane (CH₄) | 0.65 |
| Nitrogen (N₂) | 11.16 |

The hydrogen to carbon monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Due to more reforming taking place at a higher temperature in the plasma reformer, more Fischer-Tropsch tailgas must be recycled to lower the H₂:CO ratio of the synthesis gas. This causes more build up of inert nitrogen gas in the gas loop around the Fischer-Tropsch synthesis unit. Nonetheless more useable synthesis gas (H₂+CO) is produced than for Examples 1 and 2. Including the plasma reformer in the simulation and simulating the autothermal reformer at a temperature of 900° C. results in a predicted saving of 20% in oxygen consumption for the autothermal reformer.

The primary products are sent to a product-upgrading unit and the waxy syncrude is worked up into a diesel, naphtha and LPG fraction. The quantities of marketable product predicted by the simulation are shown in Table 7.

TABLE 7
Marketable Fischer-Tropsch Products (barrels/day)

| Product | Value |
|---|---|
| Fischer-Tropsch Diesel | 29151 |
| Fischer-Tropsch Naphtha | 9195 |
| Fischer-Tropsch LPG | 1241 |
| Total | 39587 |

Including the plasma reformer in the simulation and simulating the autothermal reformer at a temperature of 900° C. increase the production of marketable products by 16.8% over the base case of Example 1 and by 15.6% over Example 2.

The plasma reformer requires a duty of around 149 MW that is provided by utilizing the excess medium pressure steam generated in the Fischer-Tropsch synthesis unit for generating the electricity to drive the plasma torch. Due to the higher volumetric flow of syngas the Fischer-Tropsch synthesis unit experiences a higher superficial gas velocity than that used in Examples 1 and 2.

### EXAMPLE 4

In Example 4 a plasma reformer is used to heat, reform and equilibrate the raw synthesis gas at a temperature higher than that in the autothermal reformer, similar to the process shown in FIG. 1 of the drawings. For the purposes of this simulation an autothermal reformer operating temperature of 900° C. and a plasma reformer temperature of 1100° C. were used.

The hydrocarbonaceous feedstock composition is as shown in Table 1 but the feedstock flow rate is increased by 10.4% over the base case of Example 1 so as to more fully utilize the operating capacity of an existing air separation unit. This allows an extra full-size Fischer-Tropsch synthesis train to be included for 9% less oxygen consumption than the base case of Example 1.

The pre-reformed hydrocarbonaceous gas feedstock is autothermally reformed with oxygen. The simulated process includes controlling the ratio of oxygen to pre-reformed gas to control the temperature of the raw synthesis gas produced to 900° C. The raw synthesis gas is further reformed in the plasma reformer by increasing the temperature of the raw synthesis gas in an electrically generated plasma torch to a temperature of 1100° C. The predicted composition of the equilibrated synthesis gas after the plasma reformer after knocking out most of the water formed in the synthesis gas generation process is shown in Table 8.

TABLE 8
Reformed Synthesis Gas Composition ex Plasma Reformer (molar %)

| Component | Value |
|---|---|
| Water (H₂O) | 1.21 |
| Hydrogen (H₂) | 54.66 |
| Carbon Monoxide (CO) | 28.41 |
| Carbon Dioxide (CO₂) | 3.2 |
| Methane (CH₄) | 0.6 |
| Nitrogen (N₂) | 11.92 |

The hydrogen to carbon monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Due to more reforming taking place at a higher temperature in the plasma reformer, more Fischer-Tropsch tailgas must be recycled to lower the H₂:CO ratio of the synthesis gas. This causes more build up of inert nitrogen gas in the gas loop around the Fischer-Tropsch synthesis unit.

The primary products are sent to a product upgrading unit and the waxy syncrude is worked up into a diesel, naphtha and LPG fraction. The predicted quantities of marketable product are shown in Table 9.

TABLE 9
Marketable Fischer-Tropsch Products (barrels/day)

| Product | Value |
|---|---|
| Fischer-Tropsch Diesel | 31873 |
| Fischer-Tropsch Naphtha | 10719 |
| Fischer-Tropsch LPG | 1313 |
| Total | 43905 |

The production of marketable products increases by 30% over the base case of Example 1 with only 10.4% more hydrocarbonaceous feedstock required. An extra full size Fischer-Tropsch synthesis unit is included, operating at the same gas velocities as for Examples 1 and 2. The plasma reformer requires a duty of around 160 MW that is provided by utilizing the excess medium pressure steam generated in the Fischer-Tropsch synthesis unit for generating the electricity to drive the plasma torch.

### EXAMPLE 5

In Example 5 a plasma reformer is used to heat, reform and equilibrate the raw synthesis gas at a temperature higher than that in the autothermal reformer, similar to the process shown in FIG. 1 of the drawings. For the purposes of this simulation an autothermal reformer operating temperature of 900° C. and a plasma reformer temperature of 1050° C. were used.

The same hydrocarbonaceous feedstock composition was used as shown in Table 1 but the feedstock flow rate was increased by 12% over the base case of Example 1 so as to more fully utilize the capacity of an existing Air Separation Unit. This allows an extra full-size Fischer-Tropsch synthesis train to be included for 6% less oxygen consumption than the base case.

The pre-reformed hydrocarbonaceous gas feedstock is autothermally reformed with oxygen. The simulated process includes controlling the ratio of oxygen to pre-reformed gas to control the temperature of the raw synthesis gas produced to 900° C. The raw synthesis gas is further reformed in the plasma reformer by increasing the temperature of the raw synthesis gas in an electrically generated plasma torch to a temperature of 1050° C. The predicted composition of the equilibrated synthesis gas after the plasma reformer after knocking out most of the water formed in the synthesis gas generation process is shown in Table 10.

TABLE 10
Reformed Synthesis Gas Composition ex Plasma Reformer (molar %)

| Component | Value |
|---|---|
| Water (H₂O) | 1.21 |
| Hydrogen (H₂) | 54.81 |
| Carbon Monoxide (CO) | 28.60 |
| Carbon Dioxide (CO₂) | 3.81 |
| Methane (CH₄) | 1.2 |
| Nitrogen (N₂) | 9.77 |

The hydrogen to carbon monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Including the plasma reformer in the simulation results in a predicted saving of 6% in oxygen consumption for the autothermal reformer over the base case of Example 1.

The primary products are sent to a product-upgrading unit and the waxy syncrude is worked up into a diesel, naphtha and LPG fraction. The predicted quantities of marketable product are shown in Table 11.

TABLE 11
Marketable Fischer-Tropsch Products (barrels/day)

| Product | Value |
|---|---|
| Fischer-Tropsch Diesel | 32421 |
| Fischer-Tropsch Naphtha | 10862 |
| Fischer-Tropsch LPG | 1334 |
| Total | 44617 |

Including the plasma reformer in the simulation increases the production of marketable products by 31% over the base case of Example 1. The plasma reformer requires a duty of around 435 MW that could be provided by utilizing the excess medium pressure steam generated in the Fischer-Tropsch synthesis unit for generating the electricity to drive the plasma torch.

### EXAMPLE 6

In Example 6 a plasma reformer is used to heat, reform and equilibrate the raw synthesis gas at a temperature higher than that in the autothermal reformer, similar to the process shown in FIG. 1 of the drawings. For the purposes of this simulation an autothermal reformer operating temperature of 950° C. and a plasma reformer temperature of 1050° C. were used.

The same hydrocarbonaceous feedstock composition was used as shown in Table 1 but the feedstock flow rate is increased by 10.6% over the base case so as to more fully utilize the Air Separation Unit operating capacity. This allows an extra full-size Fischer-Tropsch synthesis train to be included for 1% less oxygen consumption than the base case.

The pre-reformed hydrocarbonaceous gas feedstock is autothermally reformed with oxygen. The simulated process includes controlling the ratio of oxygen to pre-reformed gas to control the temperature of the raw synthesis gas produced to 950° C. The raw synthesis gas is further reformed in the plasma reformer by increasing the temperature of the raw synthesis gas in an electrically generated plasma torch to a temperature of 1050° C. The predicted composition of the equilibrated synthesis gas after the plasma reformer after knocking out most of the water formed in the synthesis gas generation process is shown in Table 12.

TABLE 12
Reformed Synthesis Gas Composition ex Plasma Reformer (molar %)

| Component | Value |
|---|---|
| Water (H₂O) | 1.21 |
| Hydrogen (H₂) | 56.07 |
| Carbon Monoxide (CO) | 27.30 |
| Carbon Dioxide (CO₂) | 3.74 |
| Methane (CH₄) | 1.17 |
| Nitrogen (N₂) | 10.51 |

The hydrogen to carbon monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Due to more reforming taking place at a higher temperature in the plasma reformer, more Fischer-Tropsch tailgas must be recycled to lower the H₂:CO ratio of the synthesis gas. This causes more build up of inert nitrogen gas in the gas loop around the Fischer-Tropsch synthesis unit. Nonetheless more useable synthesis gas (H₂+CO) is produced than for Examples 1 and 5. Including the plasma reformer in the simulation results in a predicted saving of 1% in oxygen consumption for the autothermal reformer compared to the base case of Example 1.

The primary products are sent to a product-upgrading unit and the waxy syncrude is worked up into a diesel, naphtha and LPG fraction. The quantities of marketable product predicted by the simulation are shown in Table 13.

TABLE 13
Marketable Fischer-Tropsch Products (barrels/day)

| Product | Value |
|---|---|
| Fischer-Tropsch Diesel | 32289 |
| Fischer-Tropsch Naphtha | 10773 |
| Fischer-Tropsch LPG | 1532 |
| Total | 44594 |

Including the plasma reformer in the simulation and simulating the autothermal reformer at a temperature of 950° C. increase the production of marketable products by 31.5% over the base case of Example 1 but decreases it by 1% compared to Example 5. The plasma reformer requires a duty of around 218 MW that could be provided by utilizing the excess medium pressure steam generated in the Fischer-Tropsch synthesis unit for generating the electricity to drive the plasma torch.

### EXAMPLE 7

In Example 7 a plasma reformer is used to heat, reform and equilibrate the raw synthesis gas at a temperature higher than that in the autothermal reformer, similar to the process shown in FIG. 1 of the drawings. For the purposes of this simulation an autothermal reformer operating temperature of 1000° C. was used and a plasma reformer temperature of 1050° C.

The hydrocarbonaceous feedstock composition is as shown in Table 1 but the feedstock flow rate is increased by 4.5% over the base case of Example 1 so as to more fully utilize the Air Separation Unit operating capacity. This allows an extra full-size Fischer-Tropsch synthesis train to be included for the same oxygen consumption as the base case.

The pre-reformed hydrocarbonaceous gas feedstock is autothermally reformed with oxygen. The simulated process includes controlling the ratio of oxygen to pre-reformed gas to control the temperature of the raw synthesis gas produced to 1000° C. The raw synthesis gas is further reformed in the plasma reformer by increasing the temperature of the raw synthesis gas in an electrically generated plasma torch to a temperature of 1050° C. The predicted composition of the equilibrated synthesis gas after the plasma reformer after knocking out most of the water formed in the synthesis gas generation process is shown in Table 14.

TABLE 14

| Component | Value |
|---|---|
| Water (H₂O) | 1.22 |
| Hydrogen (H₂) | 58.38 |
| Carbon Monoxide (CO) | 30.07 |
| Carbon Dioxide (CO₂) | 5.44 |
| Methane (CH₄) | 0.95 |
| Nitrogen (N₂) | 3.94 |

The hydrogen to carbon monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Due to more reforming taking place at a higher temperature in the plasma reformer, more Fischer-Tropsch tailgas must be recycled to lower the H₂:CO ratio of the synthesis gas. This causes more build up of inert nitrogen gas in the gas loop around the Fischer-Tropsch synthesis unit. Nonetheless more useable synthesis gas (H₂+CO) is produced than for Example 1.

The primary products are sent to a product-upgrading unit and the waxy syncrude is worked up into a diesel, naphtha and LPG fraction. The predicted quantities of marketable product are shown in Table 15.

TABLE 15
Marketable Fischer-Tropsch Products (barrels/day)

| Product | Value |
|---|---|
| Fischer-Tropsch Diesel | 26336 |
| Fischer-Tropsch Naphtha | 9100 |
| Fischer-Tropsch LPG | 1400 |
| Total | 36836 |

Including the plasma reformer in the simulation increases the production of marketable products by 8% over the base case of Example 1. The plasma reformer requires a duty of around 81 MW that could be provided by utilizing the excess medium pressure steam generated in the Fischer-Tropsch synthesis unit for generating the electricity to drive the plasma torch.

### EXAMPLE 8

In Example 8 a plasma reformer is used to heat, reform and equilibrate the raw synthesis gas at a temperature higher than that in the autothermal reformer. For the purposes of this simulation an autothermal reformer operating temperature of 1050° C. and a plasma reformer temperature of 1100° C. were used.

The hydrocarbonaceous feedstock composition is as shown in Table 1 but the feedstock flow rate is increased by 1.6% over the base case so as to more fully utilize the Air Separation Unit operating capacity.

The pre-reformed hydrocarbonaceous gas feedstock is autothermally reformed with oxygen. The process includes controlling the ratio of oxygen to pre-reformed gas to control the temperature of the raw synthesis gas produced to 1050° C. The raw synthesis gas is further reformed in the plasma reformer by increasing the temperature of the raw synthesis gas in an electrically generated plasma torch to a temperature of 1100° C. The predicted composition of the equilibrated synthesis gas after the plasma reformer after knocking out most of the water formed in the synthesis gas generation process is shown in Table 16.

TABLE 16
Reformed Synthesis Gas Composition ex Plasma Reformer (molar %)

| Component | Value |
|---|---|
| Water (H₂O) | 1.22 |
| Hydrogen (H₂) | 59.17 |
| Carbon Monoxide (CO) | 30.60 |
| Carbon Dioxide (CO₂) | 5.20 |
| Methane (CH₄) | 0.43 |
| Nitrogen (N₂) | 3.38 |

The hydrogen to carbon, monoxide ratio (H₂:CO) in the synthesis gas is adjusted by varying the flow rate of the recycle of Fischer-Tropsch tailgas and particularly the carbon dioxide flow rate. The synthesis gas is mixed with an internal recycle around the Fischer-Tropsch synthesis unit and fed to the synthesis unit. Due to more reforming taking place at a higher temperature in the plasma reformer, more Fischer-Tropsch tailgas must be recycled to lower the H₂:CO ratio of the synthesis gas.

The primary products are sent to a product-upgrading unit and the waxy syncrude is worked up into a diesel, naphtha and LPG fraction. The predicted quantities of marketable product are shown in Table 17.

TABLE 17
Marketable Fischer-Tropsch Products (barrels/day)

| Product | Value |
|---|---|
| Fischer-Tropsch Diesel | 25035 |
| Fischer-Tropsch Naphtha | 8570 |
| Fischer-Tropsch LPG | 1330 |
| Total | 34935 |

Including the plasma reformer in the simulation increases the production of marketable products by 3% over the base case of Example 1. The plasma reformer requires a duty of around 57 MW that could be provided by utilizing the excess medium pressure steam generated in the Fischer-Tropsch synthesis unit for generating the electricity to drive the plasma torch.

As the autothermal reformer operating temperature increases, less electrical energy input into the plasma is required but due to less steam reforming taking place in the high temperature plasma reformer, production decreases.

### EXAMPLE 9

This Example illustrates the use of the invention in a Fischer-Tropsch synthesis process requiring gasification of coal, similar to the process shown in FIG. 2 of the drawings. For all simulated studies in this Example, a carbonaceous solid feedstock composition as shown in Table 18 was used. The simulations assumed that the feedstock was gasified in moving bed Lurgi gasifiers.

TABLE 18
Coal composition

| Component | Mass % |
|---|---|
| Fixed Carbon | 46.03 |
| Ash | 23.67 |
| Volatiles | 22.61 |
| Inherent moisture | 4.18 |
| Tar | 3.50 |

The coal composition was obtained by assuming the tar content to be 3.5 mass %, and using a proximate analysis for the other components. The proximate analysis was adjusted to accommodate for the tar content. This coal composition is typical for the coal mixtures used at Secunda in South Africa.

Two scenarios were studied, these being (1) a scenario with Lurgi gasification and autothermal reforming of methane, with recycle in the flow scheme, and (2) a scenario with a plasma torch at an operating temperature of 1050° C. being included directly after the Lurgi gasifiers, with no recycle. Where the plasma torch was included, a shift reactor had to be included in the simulation to achieve the required H₂/CO ratio, although no additional reforming was necessary. For both simulated scenarios, the H₂/CO ratio of the gas produced by the gasifiers was kept at 1.925, and the final H₂/CO ratio (after the shift reactor) was also kept at 1.925.

The amount of synthesis gas was kept constant for both simulations, and the number of gasifiers required was adjusted to achieve this synthesis gas volume. Thus, to achieve the required synthesis gas volume, 22 gasifiers are needed for scenario (1) and 16 for scenario (2). The total volume of marketable products was determined per gasifier to compare the scenarios with each other.

### Scenario (1)

It was assumed that 98% of the water and CO₂ would be stripped from the synthesis gas stream before entering the Fischer-Tropsch synthesis unit. For this base case, methane reforming and recycle were taken into account. Table 19 shows the predicted total gas entering the Fischer-Tropsch synthesis unit.

TABLE 19
Total gas entering FT, combination of gas ex gasifier
and gas ex autothermal reformer (fresh feed and recycled gas)

| Component | Mole % |
|---|---|
| ₂O | 2.58 |
| H₂ | 60.08 |
| CO | 31.21 |
| CO₂ | 1.24 |
| CH₄ | 3.77 |
| N₂ | 1.13 |

If it is assumed that all the tar that is present in the coal feed is recovered, then 10.30 kgmol/hr tar is also obtained from each gasifier. An excess of hydrogen is produced in the autothermal reformer (natural H₂/CO ratio higher than 2) but it was assumed that the additional hydrogen would be used elsewhere in the process, and was not taken into account in the feed to the Fischer-Tropsch synthesis unit. Table 20 shows the predicted quantities of marketable products.

TABLE 20
Marketable products

| Product | bbl/day |
|---|---|
| Fischer-Tropsch | 26054.09 |
| diesel | |
| Fischer-Tropsch | 8418.44 |
| naphtha | |
| Fischer-Tropsch | 1376.80 |
| LPG | |
| Tar | 276.04 |
| Total | 36125.37 |
| Total | 1642.062 |
| product/gasifier | |

In this scenario, the raw gas exiting from the gasifier is upgraded in a plasma reformer. An operating temperature of 1050° C. was assumed for the plasma torch. Since most methane reacts to form CO and H₂ (because of the high temperatures maintained, the methanation reaction's equilibrium shifts to favour formation of CO and H₂), no additional reforming is necessary and it was assumed that no gas is recycled. Table 21 shows the predicted quantities of gas from the plasma reformer.

TABLE 21
Gas ex plasma reformer

| | Plasma torch 1050° C. |
|---|---|
| Component | Mole % |
| H₂O | 28.51 |
| H₂ | 35.99 |
| CO | 24.42 |
| CO₂ | 10.46 |
| CH₄ | 0.17 |
| N₂ | 0.46 |
| H₂/CO ratio | 1.47 |

As a result of the H₂/CO ratio being too low when the gas exits the plasma reformer, a shift reactor was included in the simulated flow scheme. High-pressure steam was added to achieve an H₂/CO ratio of 1.925. All the tar is cracked due to the high temperatures in the plasma reformer. It was assumed that 98% of the water and CO₂ would be stripped from the synthesis gas stream before entering the Fischer-Tropsch synthesis unit. Table 22 shows the composition of the wet upgraded synthesis gas from the shift reactor.

TABLE 22
Wet upgraded synthesis gas ex shift reactor, entering FT
(with H₂O and CO₂ stripped out)

| | Plasma torch 1050° C. |
|---|---|
| Component | Mole % |
| H₂O | 1.61 |
| H₂ | 63.84 |
| CO | 33.26 |
| CO₂ | 0.45 |
| CH₄ | 0.11 |
| N₂ | 0.73 |

Table 23 shows the predicted quantities of marketable products.

TABLE 23
Marketable Fischer-Tropsch products (bbl/day)

| | Plasma torch |
|---|---|
| | 1050° C. |
| Fischer-Tropsch | 28457.5 |
| diesel | |
| Fischer-Tropsch | 8807.4 |
| naphtha | |
| Fischer-Tropsch | 1600.61 |
| LPG | |
| Total | 38875.51 |
| Total | 2380.62 |
| product/gasifier | |

When a plasma torch is employed, 45% more products are predicted per gasifier if the operating temperature of the plasma torch is 1050° C. and 26% less CO₂ is generated during synthesis gas production.

Table 24 provides information on predicted steam and oxygen requirements for the various scenarios.

TABLE 24
Steam and oxygen requirements for each scenario

| | | Plasma torch |
|---|---|---|
| | Base case | 1050° C. |
| Steam | 2931.00 | 4106.50 |
| (kgmol/hr) | | |
| Oxygen | 476.00 | 330.00 |
| (kgmol/hr) | | |

The high-pressure steam and oxygen requirements remain the same for the gasifier in both cases, as the H₂/CO ratio ex the gasifier was not varied for the scenarios. For the base case, additional steam and oxygen are required for reforming. For the second scenario, i.e. where the plasma torch is operated at a temperature of 1050° C., 40 mole % more high-pressure steam is required, which is used in the shift reactor to correct the H₂/CO ratio of the gas. 30 mole % less oxygen is required, as no oxygen is needed for autothermal reforming. A duty of about 73 MW per gasifier is required for the plasma torch.

The Applicant has surprisingly found that the invention, as illustrated, is more efficient at converting a hydrocarbonaceous gas feedstock or a carbonaceous feedstock into hydrogen and carbon monoxide than conventional processes, and that the cost of producing the synthesis gas, when calculated per unit of hydrogen and carbon monoxide produced, is acceptable when the best designs are compared to the conventional processes. This is achieved by making better use of the waste heat from the synthesis gas production stage and the synthesis gas conversion stage.

1. A process for upgrading raw synthesis gas comprising at least CH₄, CO₂, CO and H₂, the process including heating the raw synthesis gas by means of an electrically driven plasma torch to provide an upgraded synthesis gas comprising less CH₄ and CO₂ and more CO and H₂ than the raw synthesis gas, at least a portion of the electricity for the plasma torch being generated from waste heat from the upgraded synthesis gas.

2. (Cancelled)

3. A process as claimed in claim 1, in which the raw synthesis gas is heated to a temperature of between 1000° C. and 1600° C.

4. A process as claimed in claim 3, in which the raw synthesis gas is heated to a temperature of between 1000° C. and 1200° C.

5. (Cancelled)

6. A process for producing synthesis gas, which process includes:
reforming a hydrocarbonaceous gas feedstock which includes CH₄ autothermally with oxygen to produce a raw synthesis gas comprising at least CH₄, CO₂, CO and H₂, the ratio of oxygen to hydrocarbonaceous gas being controlled to control the temperature of the raw synthesis gas produced to 1050° C. or less but above the temperature at which soot formation occurs; and
upgrading the raw synthesis gas in a process which includes heating the raw synthesis gas by addition of energy derived from electricity to provide an upgraded synthesis gas comprising less CH₄ and CO₂ and more CO and H₂ than the raw synthesis gas.

7. A process as claimed in claim 6, in which the process for upgrading the raw synthesis gas is a process as claimed in claim 1.

8. A process as claimed in claim 6, in which reforming the hydrocarbonaceous gas feedstock includes adiabatically pre-reforming the hydrocarbonaceous gas feedstock with steam to provide a pre-reformed gas, with a steam to carbon molecular ratio of between 0.2 and 1.5 being employed to adiabatically pre-reform the hydrocarbonaceous gas feedstock.

9. (Cancelled)

10. A process as claimed in claim 8, in which the temperature of the raw synthesis gas produced is less than 950° C.

11. A process for producing synthesis gas, which process includes:
gasifying a carbonaceous feedstock under conditions suitable to provide a raw synthesis gas comprising at least CH₄, CO₂, CO and H₂; and
upgrading the raw synthesis gas in a process which includes heating the raw synthesis gas by means of an electrically driven plasma torch to provide an upgraded synthesis gas comprising less CH₄ and CO₂ and more CO and H₂ than the raw synthesis gas, at least a portion of the electricity for the plasma torch being generated from waste heat from the upgraded synthesis gas.

12. A process as claimed in claim 11, in which the process for upgrading the raw synthesis gas is a process as claimed in claim 1.

13. A process for producing a synthesis gas derived product, which process includes:
reforming a hydrocarbonaceous gas feedstock which includes CH₄ autothermally with oxygen to produce a raw synthesis gas comprising at least CH₄, CO₂, CO and H₂, the ratio of oxygen to hydrocarbonaceous gas being controlled to control the temperature of the raw synthesis gas produced to 1050° C. or less but above the temperature at which soot formation occurs;
in a synthesis gas upgrading stage, heating the raw synthesis gas by addition of energy derived from electricity to provide an upgraded synthesis gas comprising less CH₄ and CO₂ and more CO and H₂ than the raw synthesis gas;
feeding the upgraded synthesis gas, as a feedstock, to a synthesis gas conversion stage; and
in the synthesis gas conversion stage, converting the upgraded synthesis gas to a synthesis gas derived product.

14. A process as claimed in claim 13, in which the raw synthesis gas is heated by means of an electrically driven plasma torch.

15. A process as claimed in claim 13 or 14, in which the raw synthesis gas is heated to a temperature of between 1000° C. and 1600° C.

16. A process as claimed in claim 15, in which the raw synthesis gas is heated to a temperature of between 1000° C. and 1200° C.

17. A process as claimed in claim 13, in which at least a portion of the electricity is generated from waste heat from the upgraded synthesis gas.

18. A process as claimed in claim 13, in which at least a portion of the electricity is generated from waste heat from the synthesis gas conversion stage.

19. (Cancelled)

20. A process as claimed in claim 13, in which reforming the hydrocarbonaceous gas feedstock includes adiabatically pre-reforming the hydrocarbonaceous gas feedstock with steam to provide a pre-reformed gas, with a steam to carbon molecular ratio of between 0.2 and 1.5 being employed to adiabatically pre-reform the hydrocarbonaceous gas feedstock.

21. (Cancelled)

22. A process as claimed in claim 13, in which the temperature of the raw synthesis gas produced is less than 950° C.

23. A process as claimed in claim 13, in which the synthesis gas conversion stage is a Fischer-Tropsch hydrocarbon synthesis stage.

24. A process as claimed in claim 13, in which the synthesis gas conversion stage is selected from the group consisting of a methanol synthesis stage, a higher alcohol synthesis stage, and an oxoalcohol synthesis stage.

25. (Cancelled)

26. (Cancelled)
